(19) United States
(12) Patent Application Publication
(10) Pub. No.: US 2009/0123046 A1
(43) Pub. Date: May 14, 2009

(54) SYSTEM AND METHOD FOR GENERATING INTRAOPERATIVE 3-DIMENSIONAL IMAGES USING NON-CONTRAST IMAGE DATA

(75) Inventors: Peter Mielekamp, Veldhoven (NL); Robert Homan, Batenburg (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/300,160

(22) PCT Filed: May 2, 2007
(86) PCT No.: PCT/IB07/51635

§ 371 Date: Nov. 10, 2008

(30) Foreign Application Priority Data
May 11, 2006 (EP) 06113803.8

(51) Int. Cl. G06K 9/00

(52) U.S. Cl. 382/130; 382/132

(57) ABSTRACT

A method of generating intraoperative 3-dimensional image data includes the processes of acquiring baseline 3-dimensional image data of a region of interest. Non-contrast 3-dimensional image data of said region, and intraoperative 2-dimensional image data of said region are also acquired. The intraoperative 2-dimensional image data and the baseline 3-dimensional image data are each aligned to the non-contrast 3-dimensionsal image data, whereby an accurate rendering of intraoperative 3-dimensional image data results from the alignment of both the baseline 3D and intraoperative 2D image data to the non-contrast 3D image data.

The present invention relates to intraoperative imaging, and more particularly, to systems and methods for generating intraoperative 3-dimensional images using non-contrast image data.

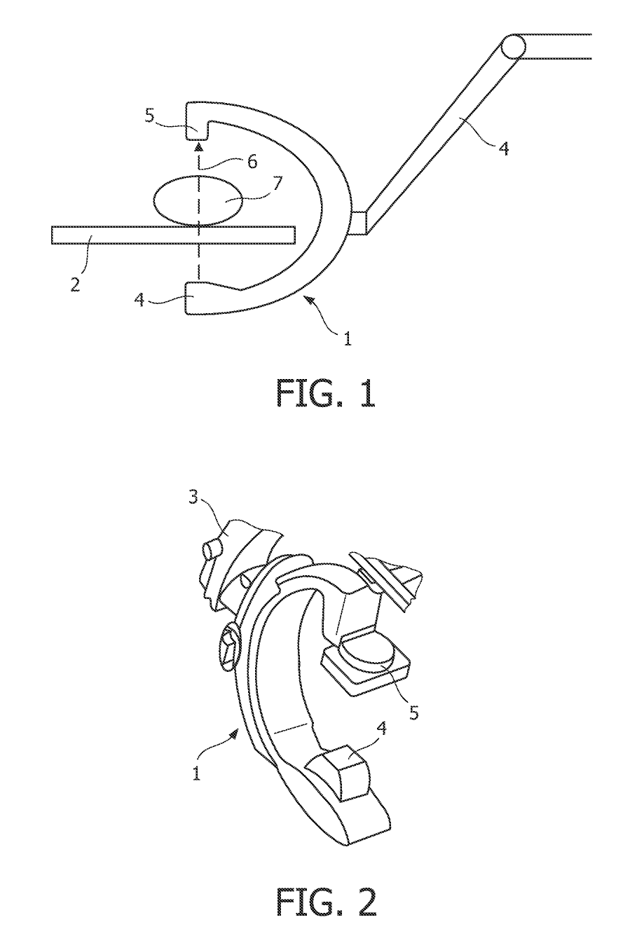

Referring to FIGS. 1 and 2 of the drawings, a typical X-ray system comprises a swing arm scanning system (C-Arm or G-Arm) 1 supported proximal a patient table 2 by a robotic arm 3. Housed within the swing arm 1, there is provided an X-ray tube 4 and an X-ray detector 5, the X-ray detector 5 being arranged and configured to receive X-rays 6 which have passed through a patient 7 and generate an electrical signal representative of the intensity distribution thereof. By moving the swing arm 1, the X-ray tube 4 and detector 5 can be placed at any desired location and orientation relative to the patient 7.

In the treatment of various types of condition and disease, a special medical application is provided by the fluoroscopic observation of the propagation of a catheter in the vascular system of the patient. Thus, during an intraoperative procedure, a catheter or guidewire is required to be advanced under X-ray surveillance (fluoroscopy), and as accurately as possible, through the vessels to an internal part of interest. While this procedure is performed, the vessel structures are made visible on a first monitor for short periods of time, in the form of two-dimensional live images, by introducing short bursts of a radio-opaque contrast agent through the catheter and obtaining X-ray images using, for example, the system described with reference to FIGS. 1 and 2 of the drawings.

For the safety of the patient, it is highly desirable to minimise the exposure to X-rays and also to minimise the amount of contrast agent introduced into the body, and it is therefore known to display, during an intervention, on a second monitor, one or more pre-operative X-ray images acquired in respect of the area of interest, so as to assist navigation. It is further desirable for the physician to be able to visualise in three dimensions, the two-dimensional fluoroscopic image data acquired during the intraoperative procedure as this will enable intraoperative data to be tracked in real time, whilst significantly reducing the contrast fluid and X-ray exposure load on the patient during the intraoperative procedure.

U.S. Pat. No. 6,666,579 describes a medical imaging system including an X-ray system such as that described with reference to FIGS. 1 and 2, wherein the swing arm is moved through an acquisition path and a plurality of two-dimensional images of a body volume are acquired at different respective positions along the acquision path. An image processor then constructs 3-dimensional volume data based on the acquired two-dimensional images and a 3-dimensional image of the body volume is displayed. A position tracking system is provided to track the relative positions of the patient and swing arm during the image acquisition, and also to track movement of a surgical instrument through the body volume during an intervention. Two-dimensional images acquired during an intervention may be superimposed on the 3-dimensional image of the body volume being displayed to the physician.

Thus, from the X-ray system, the position of the swing arm is known at which the fluoroscopy data is generated and, therefore, a rendering of the 3-dimensional volume data can be reconstructed using the same position of the swing arm as a reference. The 2-dimensional fluoroscopy data and the 3-dimensional rendering can then be displayed together. Registration of the 3-dimensional data with the two-dimensional fluoroscopy data is relatively straightforward (from the position of the swing arm) because the same X-ray system is used, with the same calibrated geometry, to generate both the 2- and 3-dimensional data.

The described approach relies upon precise alignment of the patient's position with the 3-dimensional image, obtained, typically, pre-operatively. The patient's position must reflect the true position rendered in the 3-dimensional image in order for the intraoperative image data to correctly reflect the actual position of the surgical instruments and patient's organs.

Misalignment between the patient's position and the contrast 3-dimensional image can occur during intraoperative procedures, for example, if the patient or the table is moved after the contrast 3-dimensional image is acquired. In such cases, a new 3-dimensional image of the patient is needed, the acqusition of which subjects the patient to a higher x-ray and contrasting agent load.

It may be desirable to provide systems and methods for generating 3-dimensional intraoperative images using non-contrast image data.

In one embodiment of the invention, a method of generating intraoperative 3-dimensional image data includes the processes of acquiring baseline 3-dimensional image data of a region of interest. Non-contrast 3-dimensional image data of said region, and intraoperative 2-dimensional image data of said region are also acquired. The intraoperative 2-dimensional image data and the baseline 3-dimensional image data are each aligned to the non-contrast 3-dimensionsal image data, whereby an accurate rendering of intraoperative 3-dimensional image data results from the alignment of both the baseline 3D and intraoperative 2D image data to the non-contrast 3D image data.

In another embodiment of the invention, an x-ray scanning system is presented which is operable to generate intraoperative 3-dimensional image data using non-contrast 3-dimensional image data, the x-ray scanning system including an x-ray source operable to emit x-ray radiation over a region of interest, an x-ray detector operable to receive x-ray radiation emitted from the x-ray source, and a control unit coupled to the x-ray source and x-ray detector. The control unit is adapted to control the x-ray source and the x-ray detector to acquire baseline 3-dimensional image data of a region, as well as to acquire non-contrast 3-dimensional image data of the region, and intraoperative 2-dimensional image data of the region. The control unit is further adapted to align each of the intraoperative 2-dimensional image data and the baseline 3-dimensional image data to the non-contrast 3-dimensional image data to render 3-dimensional intraoperative image data of said region of interest.

It may be seen as a gist of an exemplary embodiment of the present invention that non-contrast 3D image data can be used to align live, intraoperative 2D image data with previously-obtained baseline 3D image data to generate intraoperative 3D image data. The non-contrast 3D image can be acquired without introducing contrast agent into the patient and with a significantly decreased x-ray load placed upon the patient and operating room personnel, thereby providing advantages over the conventional techniques in which intraoperative 3D imaging of the patient at high radiation levels and contrast agent loads is required.

The following describes exemplary features and refinements of the method for generating intraoperative 3D image data, although such features will apply equally to the system as well.

In one optional embodiment, the contrast 3D image data is pre-operative image data, and the non-contrast 3D image data is intraoperative image data which is acquired during the intervention. In another embodiment of the invention, the baseline 3D image data is obtained intraoperatively. In a particular example, each of the non-contrast and baseline 3D images is x-ray fluoroscopic images. In another embodiment, the baseline 3D image data is acquired by computed tomography angiography (CTA), magnetic resonance angiography (MRA), or 3-dimensional rotational angiography (3DRA).

In a further optional embodiment, a different imaging modality is used to acquire the baseline and non-contrast 3D image data. In a particular example of this, the non-contrast 3D image data is obtained using a contrast agent-free C-Arm scanning system, and the baseline 3D image data is obtained using CTA or 3DRA. In another embodiment, the baseline 3D image data and the non-contrast 3D image data are acquired using the same imaging modality. In an example of this, a C-Arm scanning unit is used to acquire both the baseline 3D and non-contrast 3D image data, both acquired intraoperatively. The baseline 3D image data is obtained using a large number of exposures at a relatively high radiation dose, and the non-contrast 3D image data is obtained without introduction of a contrast agent into the region of interest and with a lower number of exposures and radiation dose.

In a particular embodiment of the alignment process, the intraoperative 2-dimensional image data is mapped onto a corresponding region of the non-contrast 3-dimensional image data to generate aligned non-contrast 3-dimensional image data. Subsequently, the aligned non-contrast 3-dimensional image data is mapped onto a corresponding region of the baseline 3-dimensional image data to generate intraoperative 3-dimensional image data of the region of interest.

In a further exemplary embodiment of the alignment process, the intraoperative 2-dimensional image data is mapped onto a corresponding region of the non-contrast 3-dimensional image data to generate aligned non-contrast 3-dimensional image data, and the baseline 3-dimensional image data is mapped onto a corresponding region of the non-contrast 3-dimensional image data to generate an aligned baseline 3-dimension contrast image data. Alignment of the baseline and non-contrast 3D image data can be used to provide information as to the present position of intervention material/instrument. Alignment of the intraoperative 2D image data with the baseline 3D image data can be used to provide substantially real-time position information of the intervention material/instrument relative to the artery, organ, or tissue rendered in the baseline image.

The operations of the foregoing methods may be realized by a computer program, i.e. by software, or by using one or more special electronic optimization circuits, i.e. in hardware, or in hybrid/firmware form, i.e. by software components and hardware components. The computer program may be implemented as computer readable instruction code in any suitable programming language, such as, for example, JAVA, C++, and may be stored on a computer-readable medium (removable disk, volatile or non-volatile memory, embedded memory/processor, etc.), the instruction code operable to program a computer of other such programmable device to carry out the intended functions. The computer program may be available from a network, such as the WorldWideWeb, from which it may be downloaded.

These and other aspects of the present invention will become apparent from and elucidated with reference to the embodiment described hereinafter.

An exemplary embodiment of the present invention will be described in the following, with reference to the following drawings.

FIG. 1 illustrates a schematic side view of an X-ray swing arm known in the art.

FIG. 2 illustrates a perspective view of an X-ray swing arm known in the art.

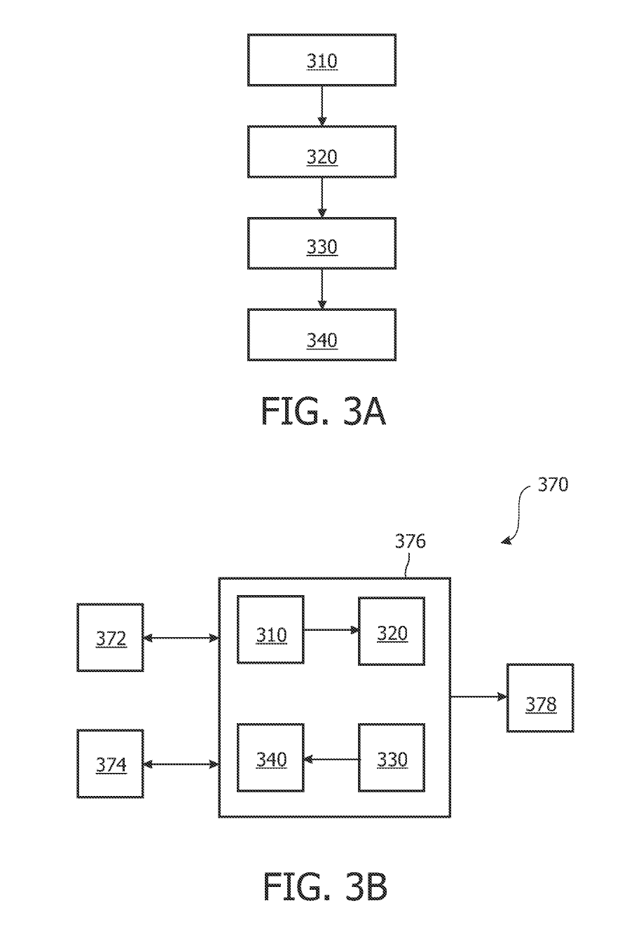

FIG. 3A illustrates an exemplary method for generating 3-dimensional intraoperative image data using non-contrast 3-dimensional data in accordance with the present invention.

FIG. 3B illustrates an exemplary x-ray scanning system for generating 3-dimensional intraoperative image data using non-contrast 3-dimensional data in accordance with the present invention.

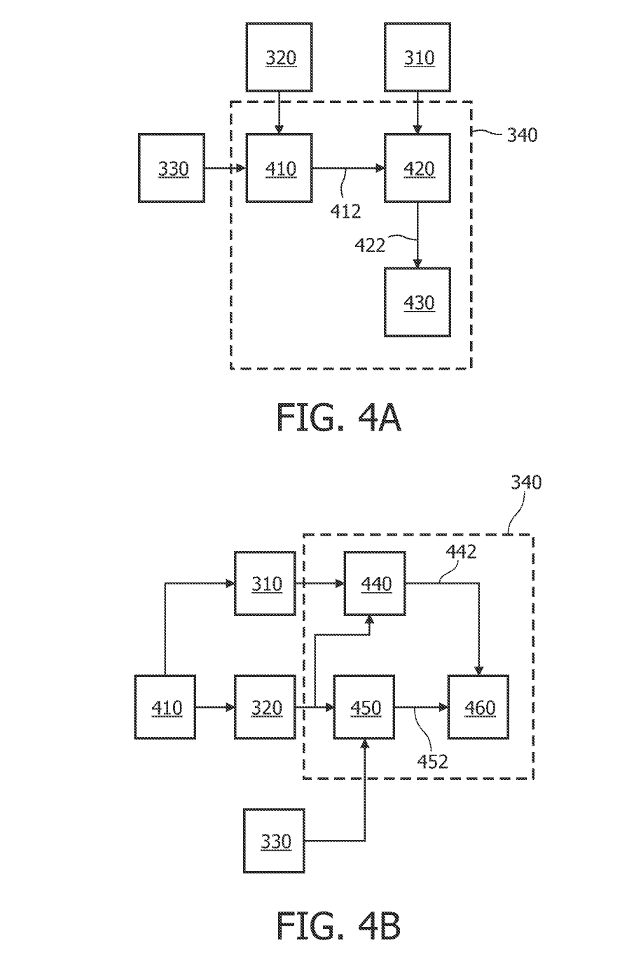

FIG. 4A illustrates a first exemplary embodiment for generating intraoperative 3D image data using non-contrast data in accordance with the invention.

FIG. 4B illustrates a second exemplary embodiment for generating intraoperative 3D image data using non-contrast data in accordance with the present invention.

FIG. 3A illustrates an exemplary method for generating intraoperative 3D image data using non-contrast 3D image data in accordance with one embodiment of the present invention. At 310, baseline 3D image data is acquired of a particular region of interest. At 320, non-contrast 3-dimensional image data of said region is acquired. At 330, intraoperative 2D image data of said region is acquired. At 340, a mutual alignment process is performed, whereby the intraoperative 2-dimensional image data and the baseline 3-dimensional image data are each brought into alignment with the non-contrast 3D image data. The alignment process results in the rendering of intraoperative 3-dimensional image data over the region of interest.

The baseline 3D image data in 310 may be acquired pre-operatively from imaging modalities such as 3D rotational angiography (3DRA), 3D ultrasound (3D US), computed tomography angiography (CTA), and magnetic resonance angiography (MRA). In another embodiment, the baseline 3D image data in 310 is obtained intraoperatively using any of the aforementioned modalities. Further particularly, in comparison with the non-contrast 3D image data, the baseline 3D image data is obtained at a high resolution, and accordingly with a high number of exposures and/or radiation dose. The baseline 3D image data may be obtained with or without the introduction of a contrast agent into the region of interest.

The non-contrast 3D image data 320 is obtained without introduction of a contrasting agent into the region of interest, and in a particular embodiment, is obtained using a C-Arm scanning system (FIGS. 1 and 2) or similar system which can be used during the intervention to provide an accurate and contemporaneous image of the patient's position. For example, a C-Arm scanning system can be used in a dynamic mode to obtain multiple non-contrast 2D scans of the patient (e.g., 50-150 2D scans), the multitude of the non-contrast 2D scans assembled to construct the non-contrast 3D image data (volume). Alternatively, other imaging modalities operable to provide non-contrast image data may be used to provide the non-contrast volume/image data as well.

The baseline 3D image data and the non-contrast 3D image data in 320 are each acquired using scan and reconstruction operations consistent with the particular imaging modality employed. Processes 310 and 320 may employ either the same or different imaging modalities. As an example, 3D contrast image data may be acquired in process 310 by means of 3DRA employing a contrast agent, and the non-contrast 3D image data may be acquired in process 320 through a C-Arm scanning system. In another embodiment, both the baseline 3D image data obtained in 310 and the non-contrast 3D image data obtained in 320 are obtained using the same imaging modality, e.g., a C-Arm scanning system, and example of which is described in FIG. 4B below. In this instance, the baseline 3D image data may be obtained in process 310 using a contrast agent and/or a higher radiation dose compared with the non-contrast 3D image data obtained in process 320. Those skilled in the art will appreciate that other combinations of image modalities which provide baseline and non-contrast 3D image data may be used as well.

An exemplary embodiment of process 330 involves acquiring the 2D intraoperative data set using x-ray fluoroscopy. Other imaging modalities may be used, for example, 2D ultrasound. The same imaging modality and apparatus (e.g., the system described in FIGS. 1 and 2) may be used in acquiring the live 2D image data and the contrast 3D image data. In a particular embodiment, the C-Arm system deployed in a static mode may be used to provide the intraoperative 2D images.

Operation 340 includes alignment operations, whereby the intraoperative 2-dimensional image data and the baseline 3-dimensional image data are each brought into alignment with the non-contrast 3D image data. Exemplary embodiments of this operation are described in FIGS. 4A and 4B below. The alignment operations 340 may be carried out using a computer, microprocessor, or similar computation device adapted to carry out the alignment operations described herein.

FIG. 3B illustrates an exemplary x-ray scanning system for generating 3-dimensional intraoperative image data using non-contrast 3-dimensional data in accordance with the present invention. The scanning system 370 includes an x-ray radiation source 372, an x-ray detector 374, and a control unit 376. In a particular embodiment, the x-ray source 372 represents the x-ray tube 4, and the x-ray detector 374 represents the x-ray detector 5 in the C-Arm scanning system shown in FIGS. 1 and 2.

The control unit 376 is adapted to control the x-ray source 372 and the x-ray detector 374 to acquire baseline 3-dimensional image data of a region, as well as to acquire non-contrast 3-dimensional image data of the region, and intraoperative 2-dimensional image data of the region. The control unit 376 is further adapted to align each of the intraoperative 2-dimensional image data and the baseline 3-dimensional image data to the non-contrast 3-dimensional image data to render 3-dimensional intraoperative image data of said region of interest. In a particular embodiment, the control unit 376 is a computer, embedded processor, or similar computing device operable to perform the described operations 310-340, particular embodiments of these operations shown in FIGS. 4A and 4B below. Further exemplary, an output device 378, such as a monitor, may be used for real time imaging of the scanned region. Alternatively or in addition, the output device 378 may be a memory for storing the scanned images for later retrieval and display.

FIG. 4A illustrates a first exemplary embodiment for generating intraoperative 3D image data using non-contrast data in accordance with the invention, with previously identified features retaining their reference numerals. In addition to the aforementioned processes 310-340, process 400 further includes processes 410-430, each representative of process 340 in which the intraoperative 2D image data and the baseline 3D image data are mutually aligned via non-contrast 3D image data and rendered. As an example, a high resolution CT system or other 3DRA system is used to acquire the baseline 3D data in process 310, and a C-Arm scanning system is used to acquire both the non-contrast 3D image data in process 320 and the intraoperative 2D image data 330.

It is to be noted that their may be any period of time between acquisition of the non-contrast 3D image data and the acquisition of the intraoperative 2D image data, so long as there is generally no misalignment which occurs between the operations. As an example, the non-contrast 3D data may be taken contemporaneously with the intraoperative 2D data, or it may be taken sometime before.

Process 410 includes mapping (i.e., geometrically associating) the intraoperative 2D image data onto a corresponding region of the non-contrast 3D image data (process 320) to generate aligned non-contrast 3-dimensional image data 412. The 2D-3D mapping process may be accomplished as described by S. Gorges et al. in “Model of a Vascular C-Arm for 3D Augmented Fluoroscopy in Interventional Radiology,” Proceedings, Part II, of 8th International Conference Medical Image Computing and Computer-Assisted Intervention MICCAI, October 2005, pgs. 214-222. Those skilled in the art will appreciate that other 2D-3D registration techniques can be used in the present invention as well.

Process 420 includes mapping the aligned non-contrast 3-dimensional image data onto a corresponding region of the baseline 3-dimensional image data to generate 3-dimensional intraoperative image data of said region of interest 422. As noted above, the baseline 3D image data/volume may be acquired using a CT scanning system, or other similar system which can provide greater resolution in comparison with the non-contrast 3D imaging modality, albeit typically under a higher x-ray and/or contrast agent dose to the patient.

An exemplary embodiment of the 3D-3D mapping process of 420 is described in U.S. Pat. No. 6,728,424, whereby the statistical measure of a spatial match is calculated between the reconstructed 3D image mask output from the 2D-3D process and the 3D baseline image data. The likelihood is calculated based on an assumption that the voxel values of the two images are probabilistically related. The likelihood is calculated for a plurality of relative transformations in iterative fashion until a transformation that maximises the likelihood is found. The transformation that maximises the likelihood provides an optimal registration and the parameters for the revised transform are supplied to an output device 430 in aligning the 2D intraoperative image and the 3D contrast image as a “fused” or composite image. Those skilled in the art will appreciate that other 3D-3D registration techniques, such as matched point, can be used in the present invention as well.

An output device 430, such as a monitor, may be employed for real-time display of the intraoperative 3D image 422. Alternative or in addtion, a microcomputer may also be used, the microcomputer operable to time-stamp and store the baseline 3D, non-contrast 3D, and intraoperative 2D image data sets, along with the mappings employed in 410 and 420. The microcomputer may be further operable to retrieve one or more intraoperative 2D images along with a baseline 3D corresponding to the time-stamped intraoperative 2D image. The microcomputer would be further operable to retrieve the mappings employed in 410 and 420 to construct the intraoperative 3D data 422 based upon the timestamp of the intraoperative 2D images, the microcomputer applying the mappings to the intraoperative 2D images to reconstruct the intraoperative 3D image 422.

While the present invention is advantageously used in procedures in which interventional materials (e.g., guide wires, stent coils, etc.) are guided into position using intraoperative 2D image data over the baseline 3D data, the present invention also finds utility in procedures such as percurtaneous biopsies, verticular draining and the like in which soft tissue imaging is needed to perform the procedure. In particular, a baseline 3D volume scan can be taken to provide soft tissue information which can be displayed with intraoperative 2D image data. The non-contrast 3D image data, in addition to providing alignment between the baseline 3D and the intraoperative 2D image data, can be further displayed with the baseline 3D image data to confirm present placement of the interventional materials/instruments. Subsequently, rendering of intraoperative 3D image data can be resumed by overlaying the intraoperative 2D image data with the baseline 3D image data.

FIG. 4B illustrates a second exemplary embodiment for generating intraoperative 3D image data using non-contrast data in accordance with the invention, whereby the baseline 3D image data includes soft tissue information, as described above. Further particularly, process 310 includes obtaining baseline 3D image data using a “soft tissue scan protocol” whereby soft tissue definition is included with the baseline 3D image data. In a particular embodiment, the soft tissue protocol implements the C-Arm scanning system described above, whereby a high number non-contrast exposures of the region of interest is acquired (e.g., 300-600) and reconstructed into a contrast or a non-contrast volume (i.e., with the introduction of a contrast agent or without). The aforementioned processes 320 and 330 may be as described previously. In a particular embodiment, non-contrast 3D image data in process 320 is acquired using a C-arm scanning system in a fast scan mode in which a relatively low number of 2D scans are made (e.g., 50-150), the scans made without the introduction of a contrast agent into the region of interest.

New process 440 includes mapping the baseline 3-dimensional image data onto a corresponding region of the non-contrast 3-dimensional image data to generate aligned baseline 3D image data 442. As noted above, this process may be carried out during a pause in the intervention to check the position of the interventional material or instrument during the proceeding. The baseline 3D image data (reconstructed, e.g., from a large number of high dose 2D scans from a C-Arm scanning system) is aligned with the non-contrast 3D image data using, for example, the 3D-3D registration process described in 420 above. Other 3D-3D mapping processes will be apparent to the skilled artisan.

New process 450 includes mapping the intraoperative 2D image data onto a corresponding region of the non-contrast 3D image data to generate aligned non-contrast 3-dimensional image data 452. In particular examples, process 450 is carried out using the 2D-3D registration process as described above in 410, and the intraoperative 2D data is fluoroscopic image data operable to provide guidance in soft tissue interventions, such as percutanous biopsies and the like. Of course, other embodiments may be used alternatively.

At 460, the aligned baseline and non-contrast 3D image data 442 and 452 are combined to render the intraoperative 3D image data, the intraoperative 3D image data being supplied to an output device, such as a monitor for real time display of the 3D intraoperative data, and/or a memory/microcomputer for storing the image data as noted above. As noted above, one or more of the illustrated processes may be carried out contemporaneously, or at the time of a later reconstruction of the intraoperative 3D image.

In summary, it may be seen as one aspect of the present invention that non-contrast 3D image data can serve as a reference for accurately aligning and rendering intraoperative 2D image data with baseline 3D image data. The non-contrast 3D image can be acquired without introducing contrast agent into the patient and with significantly decreased x-ray loading on the patient and operating room personnel, and accordingly provides advantages over the conventional techniques requiring intraoperative contrast 3D imaging.

As readily appreciated by those skilled in the art, the described processes may be implemented in hardware, software, firmware or a combination of these implementations as appropriate. In particular, a computational device such as a computer or microprocessor may be implemented to carry out operations 310-340 and 410-460. In addition, some or all of the described processes may be implemented as computer readable instruction code resident on a computer readable medium (removable disk, volatile or non-volatile memory, embedded processors, etc.), the instruction code operable to program a computer of other such programmable device to carry out the intended functions.

It should be noted that the term “comprising” does not exclude other features, and the definite article “a” or “an” does not exclude a plurality, except when indicated. It is to be further noted that elements described in association with different embodiments may be combined. It is also noted that reference signs in the claims shall not be construed as limiting the scope of the claims. Furthermore, the terms “coupling” and “connected” refer to both a direct mechanical or electrical connection between features, as well as an indirect connection, i.e., with one or more intervening features therebetween. In addition, the illustrated sequence of operations presented in flowcharts is merely exemplary, and the other sequences of the illustrated operations can be performed in accordance with the present invention.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined solely by the claims appended hereto.

1. A method for generating intraoperative 3-dimensional image data using non-contrast 3-dimensional image data, the method comprising:
acquiring baseline 3-dimensional image data of a region (310);
acquiring non-contrast 3-dimensional image data of said region (320);
acquiring intraoperative 2-dimensional image data of said region (330); and
aligning each of the intraoperative 2-dimensional image data and the baseline 3-dimensional image data to the non-contrast 3-dimensional image data to render 3-dimensional intraoperative image data of said region of interest (340).

2. The method of claim 1, wherein the baseline 3-dimensional image data comprises pre-operative image data.

3. The method of claim 1, wherein the non-contrast 3-dimensional image comprises intraoperative image data.

4. The method of claim 1, wherein a different imaging modality is employed to acquire the non-contrast 3-dimensional image data compared to the imaging modality used to acquire the baseline 3-dimensional image data.

5. The method of claim 1, wherein each of the baseline and non-contrast 3-dimensional image data comprises x-ray fluoroscopic image data.

6. The method of claim 1, wherein the baseline 3-dimensional image data comprises 3-dimensional rotational angiograph image data.

7. The method of claim 1, wherein the baseline 3-dimensional image data is acquired by means of an imaging modality selected from a group of imaging modalities consisting of computed tomography angiography, magnetic resonance angiography, and 3-dimensional rotational angiography.

8. The method of claim 1, wherein aligning each of the baseline 3-dimensional image data and the intraoperative 2-dimensional image data comprises:
mapping the intraoperative 2-dimensional image data onto a corresponding region of the non-contrast 3-dimensional image data to generate aligned non-contrast 3-dimensional image data; and
mapping said aligned non-contrast 3-dimensional image data onto a corresponding region of said baseline 3-dimensional image data to generate intraoperative 3-dimensional image data of said region of interest.

9. The method of claim 1, wherein aligning each of the baseline 3-dimensional image data and the intraoperative 2-dimensional image data comprises:
mapping said intraoperative 2-dimensional image data onto a corresponding region of said non-contrast 3-dimensional image data to generate aligned non-contrast 3-dimensional image data;
mapping said baseline 3-dimensional image data onto a corresponding region of said non-contrast 3-dimensional image data to generate an aligned baseline 3-dimension image data; and
combining said aligned non-contrast image data and said baseline 3-dimensional image data to render the intraoperative 3-dimensional image data.

10. A system operable to generate intraoperative 3-dimensional image data using non-contrast 3-dimensional image data, the system comprising:
means for acquiring baseline 3-dimensional image data of a region;
means for acquiring non-contrast 3-dimensional image data of said region;
means for aquiring intraoperative 2-dimensional image data of said region; and
means for aligning each of the intraoperative 2-dimensional image data and the baseline 3-dimensional image data to the non-contrast 3-dimensional image data to render 3-dimensional intraoperative image data of said region of interest.

11. A computer program product, resident on a computer readable medium, operable to provide instruction code for generating intraoperative 3-dimensional image data using non-contrast 3-dimensional image data, the computer program product comprising:
instruction code to acquire baseline 3-dimensional image data of a region;
instruction code to acquire non-contrast 3-dimensional image data of said region;
instruction code to acquire intraoperative 2-dimensional image data of said region; and
instruction code to align each of the intraoperative 2-dimensional image data and the baseline 3-dimensional image data to the non-contrast 3-dimensional image data to render 3-dimensional intraoperative image data of said region of interest.

12. An x-ray scanning system (370) operable to generate intraoperative 3-dimensional image data using non-contrast 3-dimensional image data, the x-ray scanning system (370) comprising:
an x-ray source (372) operable to emit x-ray radiation over a region of interest;
an x-ray detector (374) operable to receive x-ray radiation emitted from the x-ray source (372); and
a control unit (376) coupled to the x-ray source (372) and x-ray detector (374), the control unit (376) adapted to:
acquire baseline 3-dimensional image data of a region;
acquire non-contrast 3-dimensional image data of said region;
acquire intraoperative 2-dimensional image data of said region; and
align each of the intraoperative 2-dimensional image data and the baseline 3-dimensional image data to the non-contrast 3-dimensional image data to render 3-dimensional intraoperative image data of said region of interest.
